(19) United States
(12) Patent Application Publication
(10) Pub. No.: US 2026/0237100 A1
(43) Pub. Date: Aug. 13, 2026

(54) IMAGE AND VIDEO CODING METHOD WITH PREDICTION USING SUCCESSIVE TRAINING OF A MACHINE-LEARNING MODEL

(71) Applicant: GUANGDONG OPPO MOBILE TELECOMMUNICATIONS CORP., LTD., Dongguan (CN)

(72) Inventors: Olgierd STANKIEWICZ, Poznan (PL); Marek DOMANSKI, Poznan (PL); Tomasz GRAJEK, Poznan (PL); Slawomir MACKOWIAK, Poznan (PL); Slawomir ROZEK, Poznan (PL); Jakub STANKOWSKI, Poznan (PL); Maciej WAWRZYNIAK, Poznan (PL)

(73) Assignee: GUANGDONG OPPO MOBILE TELECOMMUNICATIONS CORP., LTD., Dongguan (CN)

(21) Appl. No.: 19/638,964

(22) Filed: Apr. 3, 2026

Related U.S. Application Data
(63) Continuation of application No. PCT/CN2024/120874, filed on Sep. 24, 2024.

(30) Foreign Application Priority Data
Oct. 9, 2023 (EP) 23461662.1

(51) Int. Cl. G06T 9/00; G06N 20/00

(52) U.S. Cl. CPC G06T 9/00; G06N 20/00

(57) ABSTRACT

Methods of processing at least one of image or video data, and a decoder are provided. The method includes successively decoding a plurality of fragments of an image or video. The decoding includes, for one or more fragment in the plurality of fragments: decoding a respective encoded residual fragment to obtain a decoded residual fragment; generating, using a machine-learning model, a predicted fragment from a respective reference fragment, where the respective reference fragment is selected from one or more reference fragments stored in a set of reference fragments; generating, based on the predicted fragment and the decoded residual fragment, a reconstructed fragment; storing the reconstructed fragment in the set of reference fragments; and updating parameters of the machine-learning model based on the respective reference fragment and the reconstructed fragment.

### CROSS-REFERENCE TO RELATED APPLICATIONS

This application is a continuation of International Application No. PCT/CN2024/120874 filed on Sep. 24, 2024, which claims priority to EP application EP 23461662.1 filed on Oct. 9, 2023, the disclosures of the prior applications are hereby incorporated by reference in their entireties.

### BACKGROUND

Image/video compression very often employs image prediction and encoding of only residual signal (prediction error). The encoding error (residue) can be encoded losslessly or lossy. The prediction is performed based on already encoded/transmitted fragments of an image/video, available both to the encoder and the decoder. Often, video/image coding technologies allow selection of prediction mode, which is signalled from the encoder to the decoder.

A variety of prediction modes are available to the encoder, allowing the encoder to select a better prediction mode and adapt to the content currently being encoded, which limits amount of information needed to encode the residual signal, but can also increase the amount of information needed to encode the selection of prediction mode.

Typically, a prediction scheme operates by using some prediction tool (T) to predict (P) a new fragment of an original image (O) based on previously encoded and reconstructed content (A). A prediction error, E, (also referred to as a “residual signal” or “residual fragment”) is determined based on the original image fragment, O, and the predicted fragment, P, e.g., as: E=O−P. The prediction error, E, is encoded (losslessly or lossily), giving E′. The encoded prediction error is available to both the encoder and decoder, e.g., after transmission across a network to the decoder. Information about prediction tool, T, is also transmitted to the decoder (if there is more than one prediction tool). The considered fragment of the image, O, is reconstructed (losslessly or lossily) to give a reconstructed fragment, R, e.g. as: R=P+E′. The reconstructed fragment, R, is included in the set of the already encoded content which can be used for further prediction.

The problem is to attain the best possible prediction quality, so that the prediction error is negligible, while also limiting information about the prediction mode that needs to be encoded.

### SUMMARY

The present application relates to the field of computer vision, in particular to the topic of video/image processing and video/image coding, more particularly to a method, a decoder, an encoder, and a computer-readable medium for video/image coding using a machine-learning model.

According to a first aspect, a method of processing at least one of image or video data, by a decoder is provided. The method comprises successively decoding a plurality of fragments of an image or video. The decoding comprises, for one or more fragments in the plurality of fragments: decoding a respective encoded residual fragment to obtain a decoded residual fragment; generating, using a machine-learning model, a predicted fragment from a respective reference fragment, wherein the respective reference fragment is selected from one or more reference fragments stored in a set of reference fragments; generating, based on the predicted fragment and the decoded residual fragment, a reconstructed fragment; storing the reconstructed fragment in the set of reference fragments; and updating parameters of the machine-learning model based on the respective reference fragment and the reconstructed fragment.

According to a second aspect, a decoder is provided. The decoder comprises one or more processors; and a computer-readable medium comprising computer executable instructions stored thereon which when executed by the one or more processors cause the one or more processors to perform any of the methods discussed in relation to the first aspect.

According to a third aspect, a method of processing at least one of image or video data performed by an encoder is provided. The method comprises successively encoding a plurality of fragments of an input image or video. The encoding comprises, for one or more fragments in the plurality of fragments: generating, using a machine-learning model, a predicted fragment from a respective reference fragment, wherein the predicted fragment corresponds to respective input fragment and the respective reference fragment is selected from one or more reference fragments stored in a set of reference fragments; determining a residual fragment based on the predicted fragment and the respective input fragment; encoding the residual fragment to obtain an encoded residual fragment; decoding the encoded residual fragment to obtain a decoded residual fragment; generating, based on the predicted fragment and the decoded residual fragment, a reconstructed fragment corresponding to the respective input fragment; storing the reconstructed fragment in the set of reference fragments; and updating parameters of the machine-learning model based on the respective reference fragment and the reconstructed fragment.

These and other aspects of the present application may become more readily apparent from the following description of the embodiments.

### BRIEF DESCRIPTION OF THE DRAWINGS

Embodiments will now be described, by way of example only, with reference to the accompanying drawings, in which:

FIG. 1 shows a flowchart of the operations of a decoder according to an embodiment;

FIG. 2 shows a flowchart of the operations of an encoder in accordance with this embodiment;

FIG. 3 shows an overview of a method performed by a decoder according to an embodiment;

FIG. 4 shows an overview of a method performed by an encoder according to an embodiment;

FIG. 5 shows a schematic illustration of a decoder according to an embodiment; and

FIG. 6 shows a schematic illustration of an encoder according to an embodiment.

### DETAILED DESCRIPTION

Technical solutions in the embodiments of the present application will be described clearly and completely below with reference to the accompanying drawings.

These technical solutions may be applied to a H.265/HEVC or H.266/VVC video coding system, particularly in the performance of prediction coding. However, it is to be understood that these technical solutions may applied in any other image or video coding system that involves prediction coding, whether part of a current standard or not. Furthermore, while these principles are primarily illustrated with reference to video processing, they are also applicable to other data forms, including image processing or even audio processing.

A “video” in the embodiments refers to one or more pictures. In other words, a video can include one picture or a plurality of pictures. A picture may also be referred to as an “image”.

An “encoder” is a device capable of encoding data into a bitstream, while a “decoder” is a device capable of decoding the bitstream in order to obtain the constructed data, or an approximation of the constructed data. A “bitstream” comprises a sequence of bits.

“Intra-prediction” and “inter-prediction” are two prediction operations that can be used within the HEVC and VVC frameworks, or any other hybrid-based video coding technology, for a decoder to process a received bitstream in order to obtain the original signal. In the embodiments, “original signal” or “original video” is used to refer to the data prior to encoding at the encoder 20. A reference sample in the embodiments may refer to spatially and/or temporally spaced picture data used for the prediction of a picture (or region of a picture). Intra and inter-prediction operations are also used at the encoder to make rate-distortion decisions.

In more detail, intra-prediction involves the prediction of data spatially within a single picture, without a reference to other (temporally spaced) pictures. In other words, data for a first region of a picture is used in the prediction of the data for another region of the same picture, but there is no dependence on another temporally spaced picture from another frame. In this context, the data for the first region of the picture is considered a “reference sample”.

Inter-prediction involves the prediction of data between a plurality of temporally-spaced pictures. In other words, data for a first region of a first picture is used in the prediction of data for a second region of a second picture. The first and second region may or may not be spatially separated from one another. In this context, the data for the first region of the first picture is considered a “reference sample”. It is further noted that inter-prediction may sometimes use multiple reference regions from different pictures at once, i.e. for a single prediction operation.

A “residual” in the embodiments may refer to value obtained based on an original value of a region of a picture and a prediction value of the region of the picture (e.g., the difference between the original value and the predicted value).

A “block” in the embodiments may refer to a portion of a picture comprising a plurality of pixels. For example, a picture may be portioned into two or more blocks. However, this only an example. If a picture is not partitioned, then a “block” can refer to the entire picture.

A “fragment” in the embodiments may refer to a portion of a picture. For example, a fragment may be a block of a picture. Alternatively, a fragment may be a single pixel of a picture. If a picture is not partitioned, then a “fragment” can refer to the entire picture.

A “machine-learning model” (ML model) is a model that has been trained to predict one or more sets of output data from one or more sets of input data. Examples of machine-learning models include neural networks, decision trees, random forests, support vector machines, linear regression models, Gaussian processes or the like.

A “neural network” is an example of a machine-learning model that comprises a plurality of “nodes” arranged in one or more “layers”. Each node takes as input one or more outputs of nodes in a previous layer of the neural network, or one or more initial inputs to the neural network, and generates an output based on a set of “weights” associated with the node. For example, a node may determine a weighted sum of inputs to the node and apply a non-linear function to the sum to generate the node output. The non-linear function (also referred to herein as an “activation function”) may, for example, be a sigmoid function, a tanh function, a ReLU function or the like. As used herein, the term “weight” may encompass weights and/or biases of a neural network.

Layers of a neural network may comprise one or more of: one or more fully connected layers; one or more convolutional layers; one or more recurrent layers; one or more long short-term memory (LSTM) layers; one or more attention layers; or the like. A neural network may comprise one or more skip connections between layers. A neural network may, for example, have a transformer architecture, a convolutional architecture, a residual network architecture, a recurrent architecture, an autoencoder architecture or the like.

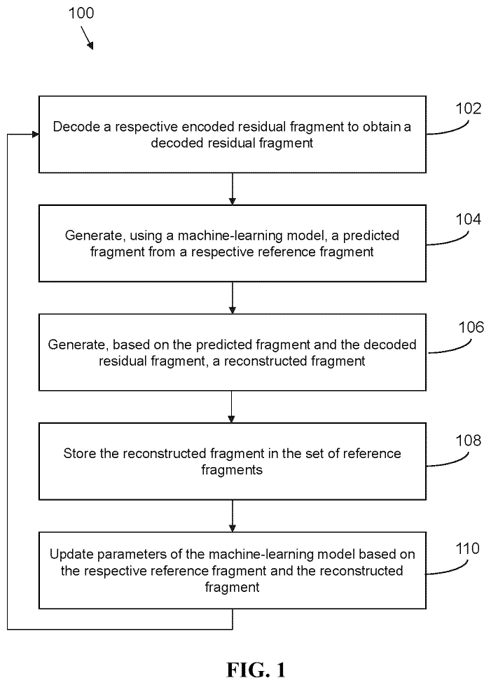

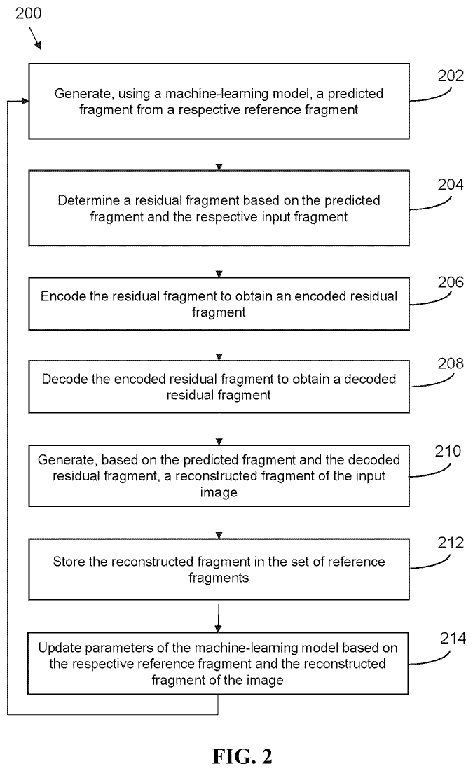

FIG. 1 shows a flowchart of the operations 100 of a decoder 50 according to an embodiment. FIG. 2 shows a flowchart of the operations 200 of an encoder 60 in accordance with this embodiment.

Turning to FIG. 1, the operations of FIG. 1 are performed successively for a sequence of encoded residual fragments of an image or video to reconstruct a corresponding sequence of image or video fragments of an image or video encoded at an encoder (for example, as described in relation to FIG. 2).

At operation 102, the decoder decodes (e.g., decompresses) an encoded residual fragment, E′, of the image/video to obtain a decoded residual fragment, E″. The encoded residual fragment may have been encoded by the encoder using a lossy or lossless compression scheme. The decoder applies the inverse transformation to decompress/decode the encoded residual fragment to obtain the decoded residual fragment. For example, the decoder may apply dequantization and/or scaling to the encoded residual fragment.

The encoded residual fragment may, for example, be extracted from a bitstream received by the decoder, e.g., via a network. The bitstream may further comprise an indication of the prediction mode used to encode the encoded residual fragment, e.g., an indication of whether ML-based prediction is used or some other prediction mode (e.g., discrete cosine transform (DCT)-based encoding or the like).

At operation 104, the decoder generates a predicted fragment, P, of the image/video from a respective reference fragment, A, using a machine-learning model. The machine-learning model may, for example be a neural network (also referred to as an “artificial neural network”, ANN). Alternatively, the machine-learning model may be a decision tree; a support vector machine; and/or a gaussian process.

The respective reference fragment is taken from a set of one or more reference fragments that is stored at the decoder. The respective reference fragment may be from the same image as the current image fragment being decoded (i.e., use intra-prediction). Alternatively, the reference fragment may be from a different image to the current image fragment being decoded (i.e., use inter-prediction), such as a different image in a sequence of images making up a video.

The set of reference fragments may comprise one or more previously decoded image/video fragments, e.g., previously decoded fragments from the same sequence of fragments as the current fragment being decoded. The set of reference fragments may be stored in a memory at the decoder, e.g., in a reference fragment buffer.

The reference fragment is input into the machine-learning model. The machine-learning model processes the input reference fragment based on current values of the parameters of the machine-learning model to generate the predicted fragment, and outputs the predicted fragment.

At operation 106, the decoder generates a reconstructed fragment, R, of the image/video based on the predicted fragment and the decoded residual fragment. The predicted fragment and the decoded residual fragment may be combined, either additively or multiplicatively, to generate the reconstructed fragment.

At operation 108, the decoder stores the reconstructed fragment of the image/video in the set of reference fragments as a new reference fragment. The reconstructed fragment is thus available for the reconstruction of further image/video fragments in the sequence.

At operation 110, the decoder updates parameters of the machine-learning model based on the respective reference fragment and the reconstructed fragment of the image/video. Any machine-learning process for updating the machine-learning model may be used to update the parameters.

For example, the predicted fragment generated from the respective reference fragment by the machine-learning model may be compared to the reconstructed fragment. The comparison may, for example, be performed using one or more loss/objective functions, such as an L1 loss, and L2 loss, a structural similarity index; and/or a multiscale structural similarity index. Based on the comparison, updates to the machine-learning model are determined. The updates are determined to reduce differences (e.g., as measured by the loss/objective function) between the predicted fragment and the corresponding reconstructed fragment. For example, an optimization routine, such as gradient descent, may be applied to the loss/objective function to determine the parameter updates for the machine-learning model.

In some examples, the decoder updates the machine-learning model immediately after the reconstruction of the fragment, i.e., the machine-learning model is updated before the next fragment is reconstructed. The updated machine-learning model is then used to reconstruct the next fragment.

Alternatively, the reconstructed fragment may be stored in a set of training data for later update of the machine-learning model. For example, the decoder can use the same machine-learning model to reconstruct a plurality of fragments, and then update the machine-learning model based on a set of training data comprising the plurality of reconstructed fragments. The next plurality of fragments are then reconstructed using the updated machine-learning model.

Alternatively, the same machine-learning model may be used to reconstruct all the fragments in an image/video, i.e., no update procedure is performed.

Following the reconstruction of the image/video fragment and, if performed, the ML-model parameter updates, the method returns to operation 102 and reconstructs the next fragment in the sequence using the (potentially updated) ML-model, and with the current reconstructed fragment now available as a reference fragment.

Turning to FIG. 2, the operations of FIG. 2 are performed successively for a sequence of input image/video fragments from one or more input images/videos to encode the fragments into a plurality of encoded residual fragments.

At operation 202, the encoder generates a predicted fragment, P, of the input image/video from a respective reference fragment, A, using a machine-learning model. The machine-learning model may, for example be a neural network (also referred to as an “artificial neural network”, ANN). Alternatively, the machine-learning model may be a decision tree; a support vector machine; and/or a gaussian process.

The respective reference fragment is taken from a set of one or more reference fragments that is stored at the encoder that correspond to previously encoded image/video fragments. The set of reference fragments may be stored in a memory at the encoder, e.g., in a reference fragment buffer.

The reference fragment is input into the machine-learning model. The machine-learning model processes the input reference fragment based on current values of the parameters of the machine-learning model to generate the predicted fragment of the image/video, and outputs the predicted fragment.

At operation 204, the encoder determines a residual fragment, E, (also referred to as an “error fragment”) for the input image/video fragment based on the predicted fragment and the respective input fragment. For example, the encoder may subtract the predicted fragment from the input fragment to determine the residual fragment. Alternatively, the encoder may divide the input fragment by the predicted fragment to obtain the residual fragment.

At operation 206, the encoder encodes the residual fragment to obtain an encoded residual fragment, E′. In some examples, the encoder uses a lossless compression scheme to encode the residual fragment. In some examples, the encoder uses a lossy compression scheme to encode the residual fragment. For example, the encoder may apply quantization and/or binarization to the residual fragment.

In some embodiments, the encoder also determines one or more further residual fragments, each using a different prediction scheme. Properties of the residual fragments (i.e., the ML-generated residual fragment and the one or more further residual fragments) are compared, and a prediction scheme for encoding the fragment selected based on the comparison. For example, the prediction scheme that results in the smallest encoded residual fragment (e.g., an encoded residual fragment with the smallest number of bits) may be selected by the encoder.

The encoder may use the selected prediction mode to encode the residual fragment into a bitstream. An indication of which prediction mode has been selected may also be encoded into the bitstream. The bitstream (also referred to as an “encoded bitstream”) may be transmitted across a network to a decoder and/or stored in a memory.

At operation 208, the encoder decodes the encoded residual fragment to obtain a decoded residual fragment, E″. For example, the encoder may apply dequantization and/or scaling to the encoded residual fragment. At operation 210, the encoder generates a reconstructed fragment of the input image/video based on the predicted fragment and the decoded residual fragment. At operation 212, the encoder stores the reconstructed fragment in the set of reference fragments. At operation 214, the encoder updates parameters of the machine-learning model based on the respective reference fragment and the reconstructed fragment of the input image/video. The machine-learning model update can, for example, be performed immediately after the reconstruction of the image fragment, i.e., the machine-learning model is updated before the next image fragment is reconstructed. Alternatively, the reconstructed image fragment may be stored in a set of training data for later update of the machine-learning model. Operations 208-214 correspond to an encoder-side implementation of operations 102-110 of the decoder respectively, and for brevity their description is omitted here.

In examples where a non-ML-based prediction mode is selected, operations 208-214 may be omitted, i.e., the machine-learning model is not updated. Instead, the encoder decompresses the encoded residual fragment, and reconstructs the image/video fragment using a corresponding inverse operation to the prediction mode used to encode the residual fragment. The reconstructed fragment is then stored in the set of reconstructed fragments. In some examples, the machine-learning model is updated even if a non-ML-based prediction mode is used. The machine-learning model update can, for example, be performed immediately after the reconstruction of the image fragment, i.e., the machine-learning model is updated before the next image fragment is reconstructed. Alternatively, the reconstructed image fragment may be stored in a set of training data for later update of the machine-learning model.

The encoder then returns to operation 202, and encodes the next fragment of the input image/video. However, the reconstructed fragment for the current fragment is now available for use by the encoder in the prediction. In examples where ML-based prediction was used, the machine-leaning model may also have updated parameters.

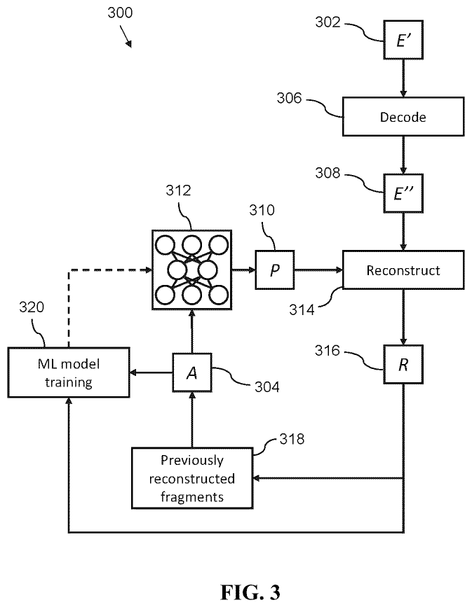

FIG. 3 shows a schematic overview of a method 300 performed by a decoder 50 according to an embodiment. The method 300 may correspond to the method 100 of FIG. 1.

The decoder receives a sequence of encoded residual fragments 302, E′. The encoded residual fragments 302 are encoded in a bitstream. Each encoded residual fragment 302 corresponds to a respective fragment of one or more images/videos that have been encoded (for example, encoded using the method of FIGS. 2 and/or 4). The goal of the decoder is to reconstruct these one or more images/videos from the encoded residual fragments 302 and previously reconstructed fragments 304, A.

The encoded residual fragments may, for example, be received over a network from an encoder or storage system, e.g., the encoded fragments 302 are transmitted to the decoder from a source system. Alternatively, the decoder may receive the encoded residual fragments 302 from a memory local to the decoder, e.g., retrieve the encoded residual fragments 302 from a memory of the decoder.

Each encoded residual fragment 302 may have been encoded/compressed into the bitstream using a lossy or lossless compression scheme. When decoding a fragment, the encoder therefore decodes 306 the corresponding encoded residual fragment 302, e.g., using an inverse/decompression scheme, to obtain a decoded residual fragment 308, E″. The bitstream may, in some examples, contain an indication of the encoding/compression scheme used by the encoder. Alternatively, the decompression scheme may be known by the decoder in advance, e.g., be fixed.

The decoder generates a predicted image fragment 310, P, from a previously reconstructed fragment 304 (also referred to as a “reference fragment”), stored at the decoder using a machine-learning model 312. The previously reconstructed fragments 304 may correspond to previously decoded fragments of the same image as the fragment currently being decoded (i.e., the decoder is using intra-prediction). Alternatively or additionally, the previously reconstructed fragments 304 may correspond to previously decoded fragments of a different image (i.e., the decoder is using inter-prediction). In some embodiments, for each encoded residual fragment 302, the identity of the corresponding previously reconstructed fragments 304 may be signalled in the bitstream. Alternatively, the identity of the corresponding previously reconstructed fragment 304 to be used with each encoded residual fragment 302 may be determined using one of one or more predefined schemes. For example, the previously reconstructed fragment 304 to be used with each encoded residual fragment 302 may corresponding to a neighbouring fragment of the image/video being decoded, e.g., the fragment to the left, to the left-top, to the top, to the right-top, etc., of the current fragment being decoded. In some examples, the scheme used for each fragment may be signalled in the bitstream, e.g., on a fragment-by-fragment basis or for a group of fragments.

In any case, the selected previously reconstructed fragment 304 is input into the machine-learning model 312, which processes the previously reconstructed fragment 304 based on current values of parameters (e.g., weights and/or biases) of the machine-learning model 312 to generate the predicted fragment 310, and outputs the predicted fragment 310 from the model 312.

The predicted fragment 310 is then combined with the decoded residual fragment 308 in a reconstruction process 314 to obtain a reconstructed fragment 316, R. For example, the reconstructed fragment 316 may be obtained by summing the predicted fragment 310 and the decoded residual fragment 308, i.e., R=E″+P. In some alternative embodiments, the reconstructed fragment 316 may be obtained by multiplying the predicted fragment 310 and the decoded residual fragment 308, i.e., R=E″*P.

The reconstructed fragment 316 is output for use in reconstruction of the original image/video (not shown). Furthermore, the reconstructed fragment 316 is output to a set of previously reconstructed fragments 318 for potential use in decoding future fragments in the sequence, e.g., stored in a buffer of reference fragments at the decoder.

The reconstructed fragment 316 is also output to a machine-learning training process 320. The ML training process 320 uses the reconstructed fragment 316 and the previously reconstructed fragment 304 (or the predicted fragment 310 generated from it) to update parameters of the machine-learning model 312, with a training goal of reducing differences between the reconstructed fragment 316 and the previously reconstructed fragment 304.

For example, the predicted fragment 310 output by the machine-learning model 312 based on the previously reconstructed fragment 304 may be compared to the current reconstructed fragment 316 using a loss/objective function, L. The objective function may be based on a difference between the predicted fragment 310 and the current reconstructed fragment 316, i.e., L=L (R−P), such as an L1 (e.g., L=|R−P|) or L2 loss (e.g., L=|R−P|²).

An optimisation routine, such as gradient descent or the like, may be applied to the loss/objective function top determine the updates to the parameters of the machine-learning model 312. In some embodiments, the optimisation routine may be an iterative routine. At each iteration, the machine-learning model generates a candidate predicted fragment from the previously reconstructed fragment 304 based on values of the parameters of the machine-learning model 312 for the iteration. The candidate predicted fragment is compared to the reconstructed fragment 316 using the loss/objective function, and gradients of the loss/objective function with respect to the parameters of the machine-learning model determined, e.g., using backpropagation. A set of machine-learning model parameters for the next iteration are then determined based on the gradients of the loss/objective function and the values of the parameters for the current iteration using an update rule, e.g., based on gradient descent.

The optimisation routine may be applied until a threshold condition is satisfied. The threshold condition may, for example, be a threshold number of iterations of the optimisation routine, e.g., 1, 2, 4, 8, 16. Alternatively, the threshold condition may be that the value of the loss/objective function for a candidate predicted fragment is below a threshold value.

Once the optimisation routine is complete, the resulting machine-learning model parameters are stored for use when decoding the next fragment of the image/video in the sequence of fragments.

Following this, the next fragment of the image/video in the sequence of fragments is decoded using the same process, but now with reconstructed image fragment 316 for this image fragment available for use in the decoding, and with updated parameters of the machine-learning model 312 (if the machine-learning has been updated).

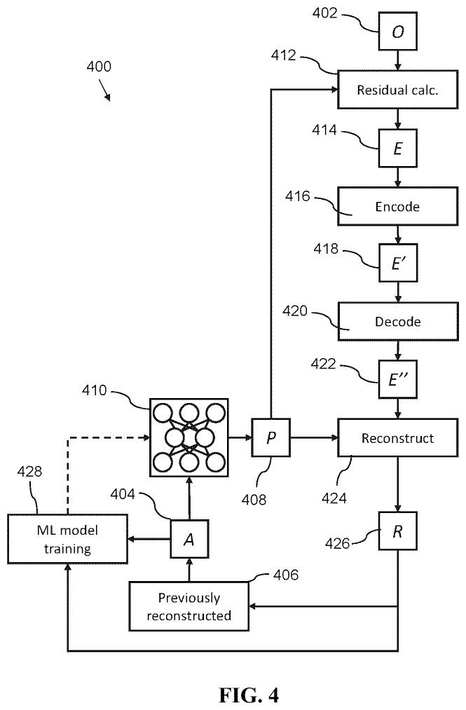

FIG. 4 shows a schematic overview of a method 400 performed by an encoder 60 according to an embodiment. The method 400 may correspond to the method 200 of FIG. 2.

The encoder receives an input fragment 402, O, of an input image, I, (either a single image or an image taken from a video) and obtains a reference fragment 404, A, from a set of previously encoded fragments 406 for use in encoding the input fragment 402. The set of previously encoded fragments 406 may comprise fragments from the input image, and/or from one or more further images, e.g., images in a sequence of images that form a video.

The encoder may select the reference fragment 404 from the set of previously encoded fragments 406 based on a similarity to the input fragment 402, e.g., the most similar reference fragment is selected. Alternatively, the reference fragment 404 may correspond to a fragment with a predefined spatial location in the image to the input fragment 402. For example, the reference fragment 404 may be a neighbouring fragment from the input image, e.g., a fragment to the left, the left-top, the top, or to the right-top. Alternatively, the reference fragment 404 may be a fragment from another input image, e.g., a fragment at the same location or a neighbouring location in another image (e.g., in a preceding/following image in a sequence of images forming a video).

The encoder uses the reference fragment 404 to generate a predicted fragment 408, P, by applying a machine-learning model 410 to the reference fragment 404. The reference fragment 404 is input into the machine-learning model 410, which processes the reference fragment 404 based on the current values of parameters of the machine-learning model (e.g., weights and/or biases) to generate the predicted fragment 408.

The encoder uses a residual calculator 412 to generate a residual/error fragment 414, E, from the input fragment 402 and the predicted fragment 408. For example, the encoder may subtract the predicted fragment 408 from the input fragment 402 to obtain the residual fragment 414, i.e., E=O−P. Alternatively the encoder may divide the input fragment 402 by the predicted fragment 408 to obtain the residual fragment 414, i.e., E=O/P.

The encoder then encodes 416 (e.g., compresses) the residual to obtain an encoded (compressed) residual fragment 418, E'. In some examples, the encoder uses a lossy compression scheme to encode the residual fragment. In some examples, the encoder uses a lossless compression scheme to encode the residual fragment. The encoded residual fragment 418 may be included in a bitstream, along with side information indicating, e.g., the prediction mode used, the identity of the reference fragment and/or the like.

In some implementations, the encoder then compares the encoded residual fragment 418 to one or more further encoded residual fragments of the same input fragment 402, each determined using a different prediction scheme, e.g., non-ML-based prediction schemes. The encoder then selects a prediction scheme based on the comparison, and encodes the residual fragment generated from the selected scheme into the bitstream (not shown).

The encoder then decodes/decompresses 420 the encoded residual fragment 418 to obtain a decoded residual fragment 422, E″, i.e., using the inverse to the encoding process 416. In examples where the encoding process 416 is a lossless compression scheme, the decoded residual fragment 422 is identical to the residual/error fragment 414, i.e., E″=E. In examples where the encoding process 416 is a lossy compression scheme, the decoded residual fragment 422 is an approximation to the residual/error fragment 414, i.e., E″≈E.

The encoder generates a reconstructed fragment 426, R, using a reconstruction process 424 that is the inverse to the residual calculation process 412. For example, in embodiments where the residual calculation process 412 subtracts the predicted fragment 408 from the input fragment 402, the reconstruction process 424 adds the decoded residual fragment 422 to the predicted fragment 408, i.e., R=E″+P. In embodiments where the residual calculation process 412 divides input fragment 402 by the predicted fragment 408, the reconstruction process 424 multiplies the decoded residual fragment 422 to the predicted fragment 408, i.e., R=E″*P.

The reconstructed fragment 426 is output to a set of previously encoded fragments 406 for potential use in encoding image fragments in the sequence, e.g., stored in a buffer of reference fragments at the encoder.

The reconstructed fragment 426 is also output to a machine-learning training process 428. The machine-learning process 428 uses the same procedure as the decoder machine-learning process 320 described in relation to FIG. 3, which is not repeated here for brevity. Use of the same ML training process on the same training data (i.e., the same reference fragment 304, 404 and the same reconstructed fragment 316, 426) at both the encoder and decoder ensures that the encoder and decoder maintain identical copies of the machine-learning model 320, 428, without having to transfer parameter update values between them.

Following this, the next fragment of the image/video in the sequence of fragments is encoded using the same process, but now with the reconstructed fragment 426 for this image fragment available for use in the decoding, and with updated parameters of the machine-learning model 410, if the machine-learning model has been updated.

An example of such an encoding process is a modified JPEG compression technology. An image is encoded in macroblocks of size of 16×16 pixels. In standard JPEG, the sole prediction tool is the prediction of discrete cosine (DC)C coefficients of a DC transform. In the modified JPEG compression technology, a machine-learning based prediction mode, as described herein, is also available, e.g. a prediction mode that employs an artificial neural network (ANN).

During encoding, the macroblock currently being encoded (O) is predicted (giving samples P) based on the immediately previously encoded macroblock (e.g., the macroblock to the left). Two prediction modes are available to the encoder: the DCT-based prediction mode (PDC) and the machine-learning based prediction mode (PANN).

A prediction error (i.e., a residual signal) is calculated as E=O−P in the encoder for both prediction modes, giving EDC and EANN, for PDC and PANN respectively. The prediction errors EDC and EANN are speculatively encoded (e.g., quantized and binarized) in order to check which mode results in a lesser bitstream. The encoder selects the better encoding mode, and respectively transmits EDC or EANN, along with information about selected prediction mode, which allows for the reconstruction (e.g., dequantization, scaling) of the prediction error, E′, at both the encoder and the decoder.

The macroblock of the image, O, is reconstructed by summing the prediction error and the sample, P, i.e., R=E′+P, where P is PDC or PANN, appropriate to the selected prediction mode and R is the reconstructed macroblock.

Reconstructed macroblock R is finished and can be used for further prediction. If PANN was selected, the ANN is trained using a new training example: A→R.

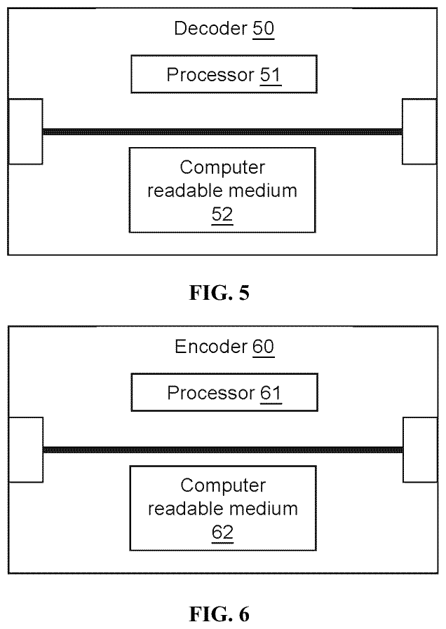

FIG. 5 shows a schematic illustration of a decoder 50 according to an embodiment. Specifically, FIG. 5 shows a schematic illustration of a decoder 50 configured to perform any of the decoder methods discussed herein. Such detailed descriptions thereof are omitted here for brevity.

As shown in FIG. 5, the decoder 50 comprises a processor 51 and a computer readable medium 52. The processor 51 and the computer readable medium 52 may be connected via a bus system. The computer readable medium is configured to store programs, instructions or codes. The processor 51 is configured to execute the programs, the instructions or the codes in the computer readable medium 52 so as to complete the operations in the decoder method embodiments herein.

Hence, in embodiments, the computer readable medium 52 is configured to store a computer program capable of being run in the processor 51, and the processor 51 is configured to run the computer program to perform steps in any of the decoder methods discussed herein.

FIG. 6 shows a schematic illustration of an encoder 60 according to an embodiment. Specifically, FIG. 6 shows a schematic illustration of an encoder 60 configured to perform any of the encoder methods discussed herein. Such detailed descriptions thereof are omitted here for brevity.

As shown in FIG. 6, the encoder 60 comprises a processor 61 and a computer readable medium 62. The processor 61 and the computer readable medium 62 may be connected via a bus system. The computer readable medium is configured to store programs, instructions or codes. The processor 61 is configured to execute the programs, the instructions or the codes in the computer readable medium 62 so as to complete the operations in the decoder method embodiments herein.

Hence, in embodiments, the computer readable medium 62 is configured to store a computer program capable of being run in the processor 61, and the processor 61 is configured to run the computer program to perform steps in any of the encoder methods discussed herein.

Embodiments of the invention can also provide a computer-readable medium having computer-executable instructions to cause one or more processors of a computing device to carry out the method of any of the embodiments of the invention.

Examples of computer-readable media include both volatile and non-volatile media, removable and non-removable media, and include, but are not limited to: solid state memories; removable disks; hard disk drives; magnetic media; and optical disks. In general, the computer-readable media include any type of medium suitable for storing, encoding, or carrying a series of instructions executable by one or more computers to perform any one or more of the processes and features described herein.

Since a machine-learning model used for prediction is trained successively on each reconstructed image fragment during encoding and decoding, the prediction is successively adapted to the characteristics of the encoded content. This can result in more efficient encoding of image fragments, e.g., a reduced bit size of an encoded image fragment. Furthermore, as the machine-learning model used for prediction is trained in the encoder and the decoder on the same data, no information about update of the machine-learning model (e.g. values of updated weights/parameters of an Artificial Neural Network) is needed to be transmitted or predefined.

It will be appreciated that the functionality of each of the components discussed can be combined in a number of ways other than those discussed in the foregoing description.

For example, in some embodiments, the functionality of more than one of the discussed devices can be incorporated into a single device. In other embodiments, the functionality of at least one of the devices discussed can be split into a plurality of separate (or distributed) devices.

Conditional language such as “may”, is generally used to indicate that features/steps are used in a particular embodiment, but that alternative embodiments may include alternative features, or omit such features altogether.

Furthermore, the method steps are not limited to the particular sequences described, and it will be appreciated that these can be combined in any other appropriate sequences. In some embodiments, this may result in some method steps being performed in parallel. In addition, in some embodiments, particular method steps may also be omitted altogether.

While certain embodiments have been discussed, it will be appreciated that these are used to exemplify the overall teaching of the present invention, and that various modifications can be made without departing from the scope of the invention. The scope of the invention should is to be construed in accordance with the appended claims and any equivalents thereof.

Many further variations and modifications will suggest themselves to those versed in the art upon making reference to the foregoing illustrative embodiments, which are given by way of example only, and which are not intended to limit the scope of the invention, that being determined by the appended claims.

The above disclosure also encompasses the features noted below. The features may be combined in various manners and are not limited to the combinations noted below.

According to a first aspect, a method of processing image and/or video data, by a decoder is provided. The method comprises successively decoding a plurality of fragments of an image or video. The decoding comprises, for one or more fragments in the plurality of fragments: decoding a respective encoded residual fragment to obtain a decoded residual fragment; generating, using a machine-learning model, a predicted fragment from a respective reference fragment, wherein the respective reference fragment is selected from one or more reference fragments stored in a set of reference fragments; generating, based on the predicted fragment and the decoded residual fragment, a reconstructed fragment; storing the reconstructed fragment in the set of reference fragments; and updating parameters of the machine-learning model based on the respective reference fragment and the reconstructed fragment.

In some embodiments, the set of reference fragments comprises one or more previously reconstructed fragments.

In some embodiments, predicting, using the machine-learning model, the predicted fragment from a respective reference fragment may comprise: inputting the respective reference fragment into the machine-learning model; processing, by the machine-learning model, the respective reference fragment based on current values of parameters of the machine-learning model to generate the predicted fragment; and outputting, from the machine-learning model, the predicted fragment.

In some embodiments, updating parameters of the machine-learning model based on the respective reference fragment and the reconstructed fragment may comprise: comparing the predicted fragment generated from the respective reference fragment with the reconstructed fragment; and updating parameters of the machine-learning model to reduce a difference between the predicted fragment from the respective reference fragment and the reconstructed fragment. Comparing the predicted fragment from the respective reference fragment with the reconstructed fragment may comprise: determining the value of an objective function based on the predicted fragment and the reconstructed fragment. The objective function may comprise one or more of: an L1 loss; an L2 loss; a structural similarity index; and/or a multiscale structural similarity index. Updating parameters of the machine-learning model to reduce a difference between the predicted fragment from the respective reference fragment and the reconstructed fragment may comprise: applying an optimisation routine to the objective function.

In some embodiments, generating, based on the predicted fragment and the decoded residual fragment, the reconstructed fragment may comprise: summing the predicted fragment and the decoded residual fragment. Alternatively, generating, based on the predicted fragment and the decoded residual fragment, the reconstructed fragment may comprise: multiplying the predicted fragment and the decoded residual fragment.

In some embodiments, the respective reference fragment corresponds to a neighbouring fragment to the reconstructed fragment.

In some embodiments, the machine-learning model comprises a neural network. The neural network may comprises one or more of: one or more fully connected layers; one or more convolutional layers; one or more recurrent layers; one or more skip connections; and/or one or more attention layers.

Alternatively, the machine-learning model may comprise: a decision tree; a support vector machine; and/or a gaussian process.

In some embodiments, the method further comprises: receiving, from a network, a bitstream comprising the encoded residual fragments. The bitstream may further comprise one or more of: data indicating that the machine-learning model is to be used to decode the encoded residual fragments; and/or data indicating the identity of the reference fragment.

In some embodiments, the encoded residual fragments are lossily encoded. Alternatively, in some embodiments, the encoded residual fragments are losslessly encoded.

In some embodiments, the fragment is an image pixel or an image block.

According to a second aspect, a computer-readable medium is provided. The computer-readable medium comprises computer executable instructions stored thereon which when executed by a computing device cause the computing device to perform any of the methods discussed in relation to the first aspect.

According to a third aspect, a decoder is provided. The decoder comprises one or more processors; and a computer-readable medium comprising computer executable instructions stored thereon which when executed by the one or more processors cause the one or more processors to perform any of the methods discussed in relation to the first aspect.

According to a fourth aspect, a method of processing image and/or video data performed by an encoder is provided. The method comprises successively encoding a plurality of fragments of an input image or video. The encoding comprises, for one or more fragments in the plurality of fragments: generating, using a machine-learning model, a predicted fragment from a respective reference fragment, wherein the predicted fragment corresponds to respective input fragment and the respective reference fragment is selected from one or more reference fragments stored in a set of reference fragments; determining a residual fragment based on the predicted fragment and the respective input fragment; encoding the residual fragment to obtain an encoded residual fragment; decoding the encoded residual fragment to obtain a decoded residual fragment; generating, based on the predicted fragment and the decoded residual fragment, a reconstructed fragment corresponding to the respective input fragment; storing the reconstructed fragment in the set of reference fragments; and updating parameters of the machine-learning model based on the respective reference fragment and the reconstructed fragment.

In some embodiments, the set of reference fragments comprises one or more previously encoded fragments.

In some embodiments, predicting, using a machine-learning model, the predicted fragment from a respective reference fragment comprises: inputting the respective reference fragment into the machine-learning model; processing, by the machine-learning model, the respective reference fragment based on current values of parameters of the machine-learning model to generate the predicted fragment; and outputting, from the machine-learning model, the predicted fragment.

In some embodiments, updating parameters of the machine-learning model based on the respective reference fragment and the reconstructed fragment comprises: comparing the predicted fragment from the respective reference fragment with the reconstructed fragment; and updating parameters of the machine-learning model to reduce a difference between the predicted fragment from the respective reference fragment and the reconstructed fragment. In some embodiments, comparing the predicted fragment from the respective reference fragment with the reconstructed fragment comprises: determining the value of an objective function based on the predicted fragment and the reconstructed fragment. In some embodiments, the objective function comprises one or more of: an L1 loss; an L2 loss; a structural similarity index; and/or a multiscale structural similarity index. In some embodiments, updating parameters of the machine-learning model to reduce a difference between the predicted fragment from the respective reference fragment and the reconstructed fragment comprises: applying an optimisation routine to the objective function.

In some embodiments, determining a residual fragment based on the predicted fragment and the respective input fragment comprises: subtracting the predicted fragment from the respective input fragment; and generating, based on the predicted fragment and the decoded residual fragment, the reconstructed fragment comprises: summing the predicted fragment and the decoded residual fragment.

In some embodiments, determining a residual fragment based on the predicted fragment and the respective input fragment comprises: dividing the respective input fragment by the predicted fragment; and generating, based on the predicted fragment and the decoded residual fragment, the reconstructed fragment comprises: multiplying the predicted fragment and the decoded residual fragment.

In some embodiments, the respective reference fragment corresponds to a neighbouring fragment to the reconstructed fragment.

In some embodiments, the machine-learning model comprises a neural network. In some embodiments, the neural network comprises one or more of: one or more fully connected layers; one or more convolutional layers; one or more recurrent layers; one or more skip connections; and/or one or more attention layers.

In some embodiments, the machine-learning model comprises: a decision tree; a support vector machine; and/or a gaussian process.

In some embodiments, encoding the residual fragment to obtain an encoded residual fragment compromise using a lossy encoding scheme. In some embodiments, encoding the residual fragment to obtain an encoded residual fragment compromise using a lossless encoding scheme.

In some embodiments, the fragment is an image pixel or an image block.

In some embodiments, the method further comprises: transmitting the encoded residual fragments in a bitstream to a decoder. In some embodiments, the bitstream further comprises an indication of the identity of the respective reference fragment for each of the encoded residual fragments.

In some embodiments, the method further comprises: encoding the plurality of fragments with one or more further coding schemes; for one or more of the plurality of fragments: comparing a size of a residual fragment generated by each of the one or more further coding schemes and the residual fragment generated using the predicted fragment from the machine-learning model; selecting a coding scheme for the fragment based on the comparison; and encoding the fragment into a bitstream using the selected coding scheme along with an indication of the selected coding scheme.

According to a fifth aspect, a computer-readable medium is provided. The computer-readable medium comprises computer executable instructions stored thereon which when executed by a computing device cause the computing device to perform any of the methods discussed in relation to the fourth aspect.

According to a sixth aspect, an encoder is provided. The encoder comprises one or more processors; and a computer-readable medium comprising computer executable instructions stored thereon which when executed by the one or more processors cause the one or more processors to perform any of the methods discussed in relation to the fourth aspect.

According to a seventh aspect, a system is provided. The system comprises an encoder according to the sixth aspect and a decoder according to the third aspect.

1. A method of processing at least one of image or video data, the method performed by a decoder and comprising successively decoding a plurality of fragments of an image or video, the decoding comprising, for one or more fragments in the plurality of fragments:
decoding a respective encoded residual fragment to obtain a decoded residual fragment;
generating, using a machine-learning model, a predicted fragment from a respective reference fragment, wherein the respective reference fragment is selected from one or more reference fragments stored in a set of reference fragments;
generating, based on the predicted fragment and the decoded residual fragment, a reconstructed fragment;
storing the reconstructed fragment in the set of reference fragments; and
updating parameters of the machine-learning model based on the respective reference fragment and the reconstructed fragment.

2. The method of claim 1, wherein the set of reference fragments comprises one or more previously reconstructed fragments.

3. The method of any of claims 1, wherein generating, using the machine-learning model, the predicted fragment from a respective reference fragment comprises:
inputting the respective reference fragment into the machine-learning model;
processing, by the machine-learning model, the respective reference fragment based on current values of parameters of the machine-learning model to generate the predicted fragment; and
outputting, from the machine-learning model, the predicted fragment.

4. The method of claim 1, wherein updating parameters of the machine-learning model based on the respective reference fragment and the reconstructed fragment comprises:
comparing the predicted fragment from the respective reference fragment with the reconstructed fragment; and
updating parameters of the machine-learning model to reduce a difference between the predicted fragment from the respective reference fragment and the reconstructed fragment,
wherein comparing the predicted fragment from the respective reference fragment with the reconstructed fragment comprises:
determining the value of an objective function based on the predicted fragment of the image and the reconstructed fragment, and
wherein the objective function comprises at least one of: an L1 loss; an L2 loss; a structural similarity index; or a multiscale structural similarity index.

5. The method of claim 4, wherein updating parameters of the machine-learning model to reduce a difference between the predicted fragment from the respective reference fragment and the reconstructed fragment comprises:
applying an optimisation routine to the objective function.

6. The method of claim 1, wherein generating, based on the predicted fragment and the decoded residual fragment, the reconstructed fragment comprises:
summing the predicted fragment and the decoded residual fragment, or
multiplying the predicted fragment and the decoded residual fragment.

7. The method of claim 1, wherein the respective reference fragment corresponds to a neighbouring fragment to the reconstructed fragment.

8. The method of claim 1, wherein the machine-learning model comprises a neural network, and
wherein the neural network comprises at least one of: one or more fully connected layers; one or more convolutional layers; one or more recurrent layers; one or more skip connections; or one or more attention layers.

9. The method of claim 1, wherein the machine-learning model comprises at least one of: a decision tree; a support vector machine; or a gaussian process.

10. The method of claim 1, further comprising:
receiving, from a network, a bitstream comprising the encoded residual fragments,
wherein the bitstream further comprises at least one of: data indicating that the machine-learning model is to be used to decode the encoded residual fragments; or data indicating the identity of the reference fragment.

11. The method of claim 1, wherein the encoded residual fragments are lossily encoded, or the encoded residual fragments are losslessly encoded.

12. The method of claim 1, wherein the fragment is an image pixel or an image block.

13. A decoder, comprising:
one or more processors; and
a computer-readable medium comprising computer executable instructions stored thereon which when executed by the one or more processors cause the one or more processors to successively decode a plurality of fragments of an image or video,
wherein the decoding comprises, for one or more fragments in the plurality of fragments:
decoding a respective encoded residual fragment to obtain a decoded residual fragment;
generating, using a machine-learning model, a predicted fragment from a respective reference fragment, wherein the respective reference fragment is selected from one or more reference fragments stored in a set of reference fragments;
generating, based on the predicted fragment and the decoded residual fragment, a reconstructed fragment;
storing the reconstructed fragment in the set of reference fragments; and
updating parameters of the machine-learning model based on the respective reference fragment and the reconstructed fragment.

14. A method of processing at least one of image or video data, the method performed by an encoder and comprising successively encoding a plurality of fragments of an input image or video, the encoding comprising, for one or more fragments in the plurality of fragments:
generating, using a machine-learning model, a predicted fragment from a respective reference fragment, wherein the predicted fragment corresponds to respective input fragment and the respective reference fragment is selected from one or more reference fragments stored in a set of reference fragments;
determining a residual fragment based on the predicted fragment and the respective input fragment of the input image;
encoding the residual fragment to obtain an encoded residual fragment;
decoding the encoded residual fragment to obtain a decoded residual fragment;
generating, based on the predicted fragment and the decoded residual fragment, a reconstructed fragment corresponding to the respective input fragment;
storing the reconstructed fragment in the set of reference fragments;
updating parameters of the machine-learning model based on the respective reference fragment and the reconstructed fragment.

15. The method of claim 14, wherein the set of reference fragments comprises one or more previously encoded fragments.

16. The method of claim 14, wherein determining a residual fragment based on the predicted fragment and the respective input fragment comprises:
subtracting the predicted fragment from the respective input fragment; and
wherein generating, based on the predicted fragment and the decoded residual fragment, the reconstructed fragment comprises:
summing the predicted fragment and the decoded residual fragment.

17. The method of claim 14, wherein determining a residual fragment based on the predicted fragment and the respective input fragment comprises:
dividing the respective input fragment by the predicted fragment; and
wherein generating, based on the predicted fragment and the decoded residual fragment, the reconstructed fragment comprises:
multiplying the predicted fragment and the decoded residual fragment.

18. The method of claim 14, wherein encoding the residual fragment to obtain an encoded residual fragment comprises: using a lossy encoding scheme, or
encoding the residual fragment to obtain an encoded residual fragment comprises: using a lossless encoding scheme.

19. The method of claim 14, further comprising:
transmitting the encoded residual fragments in a bitstream to a decoder,
wherein the bitstream further comprises an indication of the identity of the respective reference fragment for each of the encoded residual fragments.

20. The method of claim 14, further comprising:
encoding the plurality of fragments with one or more further coding schemes;
for one or more of the plurality of fragments:
comparing a size of a residual fragment generated by each of the one or more further coding schemes and the residual fragment generated using the predicted fragment from the machine-learning model;
selecting a coding scheme for the fragment based on the comparison; and
encoding the fragment into a bitstream using the selected coding scheme along with an indication of the selected coding scheme.
